(19) United States
(12) Patent Application Publication
(10) Pub. No.: US 2025/0372777 A1
(43) Pub. Date: Dec. 4, 2025

(54) SECONDARY BATTERY

(71) Applicant: Samsung SDI Co., Ltd., Yongin-si (KR)

(72) Inventor: Taewoong JANG, Yongin-si (KR)

(21) Appl. No.: 18/927,603

(22) Filed: Oct. 25, 2024

(30) Foreign Application Priority Data
Jun. 4, 2024 (KR) 10-2024-0073339

(51) Int. Cl. H01M 50/166; H01M 50/107; H01M 50/152; H01M 50/16; H01M 50/534; H01M 50/559; H01M 50/588

(52) U.S. Cl. CPC H01M 50/166; H01M 50/107; H01M 50/152; H01M 50/16; H01M 50/534; H01M 50/559; H01M 50/588

(57) ABSTRACT

A secondary battery includes: an electrode assembly including a first electrode, a second electrode, and a separator wound between the first electrode and the second electrode, the electrode assembly having a through-hole in a core portion; a case to accommodate the electrode assembly inserted through an opening in one side of the case, the case including a first thread on a side surface of the opening; a cap assembly to seal the opening of the case, and including a cap plate having a sidewall portion comprising a second thread to correspond to the first thread; and a center pin located inside the through-hole, and to be stretched in a longitudinal direction.

### CROSS-REFERENCE TO RELATED APPLICATION

The present application claims priority to and the benefit of Korean Patent Application No. 10-2024-0073339, filed on Jun. 4, 2024, in the Korean Intellectual Property Office, the entire disclosure of which is incorporated by reference herein.

### BACKGROUND

### 1. Field

Aspects of embodiments of the present disclosure relate to a secondary battery.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

When joining components of a secondary battery, welding may mainly be performed. However, welding defects may frequently occur in the process of welding the components of the secondary battery, and in this case, a short circuit may occur in the secondary battery. When two materials for different electrodes in the secondary battery come into electrical contact with each other, and thus, an internal circuit short occurs, the temperature of the secondary battery may rapidly increase, and in serious cases, may lead to a fire.

Embodiments of the present disclosure may be directed to a secondary battery in which a cap assembly is coupled to a case.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

According to one or more embodiments of the present disclosure, a secondary battery includes: an electrode assembly including a first electrode, a second electrode, and a separator wound between the first electrode and the second electrode, the electrode assembly having a through-hole in a core portion; a case configured to accommodate the electrode assembly inserted through an opening in one side of the case, the case including a first thread on a side surface of the opening; a cap assembly configured to seal the opening of the case, and including a cap plate having a sidewall portion including a second thread to correspond to the first thread; and a center pin located inside the through-hole, and configured to be stretched in a longitudinal direction.

In an embodiment, the cap assembly may further include a terminal plate electrically connected to the first electrode, and one terminal of the center pin may be configured to press a first electrode tab of the first electrode against at least a portion of the terminal plate.

In an embodiment, one terminal of the center pin may be configured to press a second electrode tab of the second electrode against at least a portion of the case.

In an embodiment, the center pin may include: a first contact portion in contact with a first electrode tab of the first electrode; and a second contact portion in contact with a second electrode tab of the second electrode. At least one of the first contact portion or the second contact portion may include a surface having a low friction layer thereon.

In an embodiment, the low friction layer may include a binder.

In an embodiment, the center pin may include an elastic portion configured to be stretched along the longitudinal direction.

In an embodiment, opposite terminals of the center pin may be configured to be compressed by the cap assembly and the case, as the cap assembly and the case are attached to each other.

In an embodiment, the cap assembly may further include a terminal plate electrically connected to the first electrode. The center pin may be configured to press a first electrode tab of the first electrode against the terminal plate, and press a second electrode tab of the second electrode against the case by an elastic force generated when the center pin is compressed.

In an embodiment, the second thread of the cap plate may be configured to be engaged with the first thread of the case to attach the cap assembly to the case.

In an embodiment, the cap plate may include an insulating material.

In an embodiment, the cap assembly may further include a terminal plate electrically connected to the first electrode, and the terminal plate may include a body portion, and an insertion portion protruding from the body portion.

In an embodiment, the cap plate may further include a circumferential portion surrounding around a circumference of a side surface of the body portion.

In an embodiment, the insertion portion of the terminal plate may face the electrode assembly when the cap assembly is attached to the case.

In an embodiment, the cap plate may include a first cover portion, and at least a portion of the first cover portion may be located between the body portion of the terminal plate and the electrode assembly.

In an embodiment, the cap assembly may further include a first insulating layer between the first cover portion of the cap plate and the body portion of the terminal plate.

In an embodiment, one surface of the body portion opposite the insertion portion may face the electrode assembly when the cap assembly is attached to the case.

In an embodiment, the cap plate may further include a second cover portion, and at least a portion of the second cover portion may be located on the body portion of the terminal plate.

In an embodiment, the cap assembly may further include a second insulating layer between the second cover portion of the cap plate and the body portion of the terminal plate.

According to one or more embodiments of the present disclosure, a secondary battery includes: an electrode assembly including a first electrode, a second electrode, and a separator wound between the first electrode and the second electrode, the electrode assembly having a through-hole in a core portion; a case configured to accommodate the electrode assembly inserted through an opening in one side of the case, the case being electrically connected to a second electrode tab; a cap assembly configured to seal the opening of the case, and including a terminal plate connected to the first electrode; and a center pin inside the through-hole, and configured to be stretched in a longitudinal direction. A side surface of the opening of the case includes a first thread, and a circumferential portion of the cap assembly includes a second thread corresponding to the first thread. One terminal of the center pin is configured to press a first electrode tab of the first electrode against the terminal plate, and another terminal of the center pin is configured to press the second electrode tab of the second electrode against the case, as the first thread of the case and the second thread of the cap assembly are engaged and connected with each other.

In an embodiment, the center pin may include: a first contact portion in contact with the first electrode tab of the first electrode; and a second contact portion in contact with the second electrode tab of the second electrode, and at least one of the first contact portion or the second contact portion may include a surface having a low friction layer thereon.

According to some embodiments of the present disclosure, defects that may be caused by welding may be prevented by joining an area where the cap assembly is in contact with the case in the secondary battery without welding.

According to some embodiments of the present disclosure, in a cylindrical secondary battery, the electrode tab and the terminal plate may be energized by a center pin disposed in a core area of the electrode assembly, thereby eliminating or reducing the need for welding between the electrode tab and the terminal plate.

Similarly, the other electrode tab and the case may be energized by the center pin, thereby eliminating or reducing the use for welding between the electrode tab and the case. Accordingly, defects that may be caused by welding may be prevented or substantially prevented.

According to some embodiments of the present disclosure, in the secondary battery, a cover portion of the cap plate may be located to be connected to an outermost edge of the case, thereby minimizing or reducing damage that may be caused to the terminal plate. In addition, because the cap plate may include an insulating material, even if an impact is applied to the cap plate and the insulating layer 1 and the cap plate are damaged, a short circuit may not occur between the positive electrode and the negative electrode connected to the terminal plate. As such, the secondary battery according to some embodiments may improve safety by reducing the risk of a short circuit.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates a cross-sectional view of a secondary battery according to some embodiments of the present disclosure;

FIG. 2 illustrates a partial enlarged view of a secondary battery according to some embodiments of the present disclosure;

FIG. 3 illustrates a cross-sectional view of a secondary battery according to some embodiments of the present disclosure;

FIG. 4 illustrates a cross-sectional view of a secondary battery according to some embodiments of the present disclosure;

FIG. 5 illustrates an example of a center pin according to some embodiments of the present disclosure;

FIG. 6 illustrate an example of a center pin according to some embodiments of the present disclosure;

FIG. 7 illustrates an example of a center pin according to some embodiments of the present disclosure;

FIG. 8 illustrates a case and a cap assembly before being joined to each other according to some embodiments of the present disclosure;

FIG. 9 illustrates the case and the cap assembly after being joined to each other according to some embodiments of the present disclosure; and

FIG. 10 illustrates an example of a configuration of preventing a short circuit of a secondary battery.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

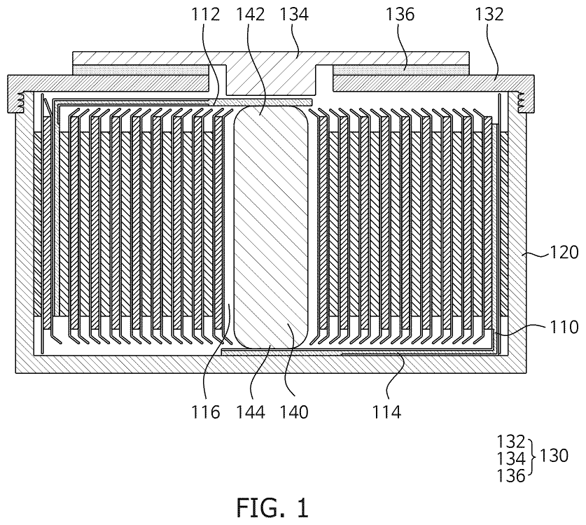

FIG. 1 illustrates a cross-sectional view of a secondary battery according to some embodiments of the present disclosure. FIG. 1 illustrates a cross-sectional view of a structure in which the secondary battery is cut in the height direction along a line crossing the center of the approximately cylindrical secondary battery. As illustrated, the secondary battery may include an electrode assembly 110, a case 120, a cap assembly 130, and a center pin 140.

The secondary battery may be a coin-kind or a button-kind of secondary battery. For example, the secondary battery may have a cylindrical shape, but the shape of the secondary battery is not limited thereto.

The electrode assembly 110 may include a first electrode, a second electrode, and a separator. In more detail, the electrode assembly 110 may be configured by winding the separator disposed between the first electrode and the second electrode. The electrode assembly 110 may be wound to form a core portion, and may include a through-hole 116 in the core portion.

The first electrode may include a first substrate, and a first active material layer located on the first substrate. A first electrode tab 112 may extend outward from a first uncoated portion of the first substrate where the first active material layer is not located, and the first electrode tab 112 may be electrically connected to a terminal plate 134 of the cap assembly 130.

The second electrode may include a second substrate, and a second active material layer located on the second substrate. A second electrode tab 114 may extend outward from a second uncoated portion of the second substrate where the second active material layer is not located, and the second electrode tab 114 may be electrically connected to the case 120. The first electrode tab 112 and the second electrode tab 114 may extend in opposite directions from each other from the first electrode and the second electrode, respectively.

In some embodiments, each of the first electrode tab 112 and the second electrode tab 114 may be covered with a cover tape. The cover tape may include an insulating material. The insulating material may provide an electrical insulation to prevent or substantially prevent a current from passing therethrough. The cover tape may prevent a short circuit from occurring in the first electrode tab 112 and the second electrode tab 114.

The first electrode may function as a positive electrode. In this case, the first substrate may include (e.g., may be composed of), for example, an aluminum foil, and the first active material layer may include, for example, a transition metal oxide. The second electrode may function as a negative electrode. In this case, the second substrate may include (e.g., may be composed of), for example, a copper foil or a nickel foil, and the second active material layer may include, for example, graphite.

The separator may function to prevent a short circuit between the first electrode and the second electrode, while allowing movement of lithium ions. The separator may include (e.g., may be composed of), for example, a polyethylene film, a polypropylene film, a polyethylene-polypropylene film, or the like, but the present disclosure is not limited thereto.

Referring to FIG. 1, the first electrode tab 112 of the first electrode may be formed on one side of the electrode assembly 110. The second electrode tab 114 of the second electrode may be formed on another side (e.g., an opposite side) of the electrode assembly 110. However, the present disclosure is not limited thereto. For example, the first electrode tab and the second electrode tab may be formed on one side (e.g., on the same side) of the electrode assembly 110.

The case 120 may accommodate the electrode assembly 110 and an electrolyte, and may define the external appearance of the secondary battery together with the cap assembly 130. The case 120 may include an approximately cylindrical sidewall portion, and a bottom portion connected to one side of the sidewall portion. However, the present disclosure is not limited thereto, and the case 120 may have various suitable shapes, such as a circular shape or a pouch shape. In addition, the case may include (e.g., may be composed of) a metal, such as aluminum, an aluminum alloy, or a nickel-plated steel, or a laminated film or a plastic that constitutes a pouch.

The case 120 may accommodate the electrode assembly 110. The electrode assembly 110 may be inserted into the case 120 through an opening formed in one side of the case 120. Thereafter, the opening of the case 120 may be closed (e.g., may be covered or sealed) by the cap assembly 130. The cap assembly 130 may be joined to (e.g., may be connected to or attached to) the one side of the case 120.

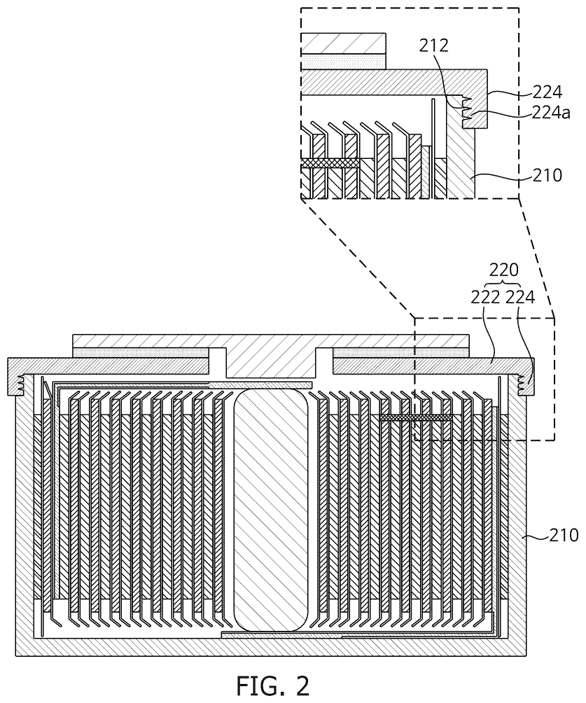

The cap assembly 130 may include a cap plate 132, the terminal plate 134, and an insulating layer 136. The cap plate 132 may seal the opening of the case 120. The cap plate 132 may be joined to (e.g., may be connected to or attached to) the side surface of the case 120 corresponding to the opening. The joined structure of the cap plate 132 and the case 120 will be described in more detail below with reference to FIG. 2.

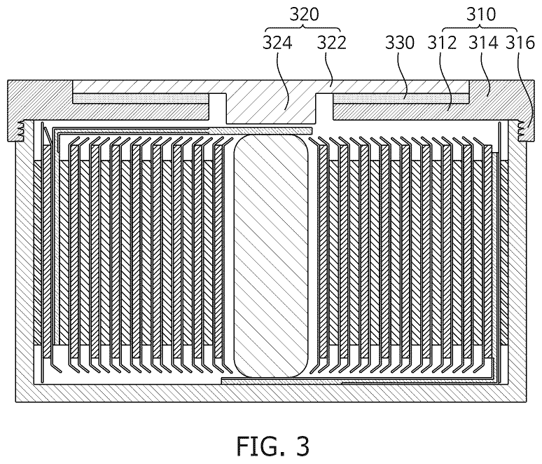

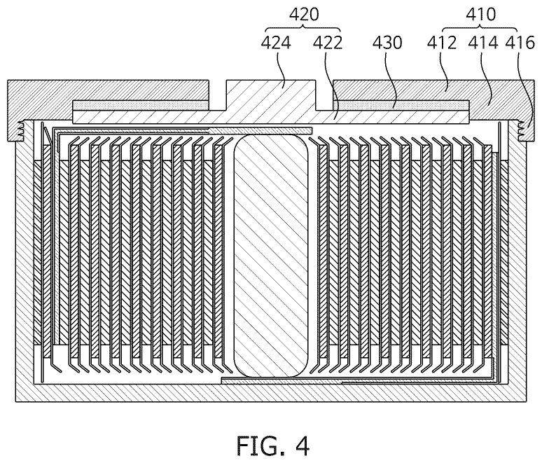

An insertion hole may be formed in the cap plate 132. In more detail, the insertion hole may be formed approximately at the center of the cap plate 132. The terminal plate 134 may be inserted into the insertion hole, and the terminal plate 134 may be joined to (e.g., may be connected to or attached to) the cap plate 132. The terminal plate 134 may include a body portion, and an insertion portion protruding from the body portion. The insertion portion of the terminal plate 134 may be inserted into the insertion hole of the cap plate 132. The joined structure of the cap plate 132 and the terminal plate 134 will be described in more detail below with reference to FIGS. 3 and 4.

In some embodiments, the cap plate 132 may include an insulating material. The insulating material may provide an electrical insulation to prevent or substantially prevent a current from passing therethrough. For example, the cap plate 132 may include a plastic with insulating properties. For example, the cap plate 132 may include polypropylene (PP), polyethylene terephthalate (PET), or polyethylene (PE).

The insulating layer 136 may be disposed between the terminal plate 134 and the cap plate 132. The insulating layer 136 may have an adhesive strength, and thus, may join (e.g., may connect or attach) the terminal plate 134 to the cap plate 132. The insulating layer 136 is formed of an insulating material, and thus, may electrically insulate between the terminal plate 134 and the cap plate 132, or between the terminal plate 134 and the case 120.

In the case 120, a first thread may be formed on the side surface of the opening. The cap plate 132 may have a sidewall portion in which a second thread is formed to correspond to the first thread of the case 120. As the first thread and the second thread are engaged with each other, the cap assembly 130 including the cap plate 132 may be rotationally joined to (e.g., may be rotationally connected to or attached to) the case 120. The joined structure of the first thread and the second thread will be described in more detail below with reference to FIG. 2.

The center pin 140 may be located inside the through-hole 116 of the electrode assembly 110. The center pin 140 may be disposed in the through-hole 116, such that the longitudinal direction of the center pin 140 and the height direction of the electrode assembly 110 are parallel to or substantially parallel to each other. In some embodiments, a first contact portion 142 may be formed at one end of the center pin 140, and a second contact portion 144 may be formed at another end (e.g., an opposite end) of the center pin 140. The first contact portion 142 may be in contact with the first electrode tab 112, and the second contact portion 144 may be in contact with the second electrode tab 114.

In some embodiments, one terminal of the center pin 140 may press the first electrode tab 112 of the first electrode against at least a portion of the terminal plate 134. For example, one terminal of the center pin 140 may press the first electrode tab against the insertion portion of the terminal plate 134. In addition, another terminal of the center pin 140 may press the second electrode tab 114 of the second electrode against at least a portion of the case 120. For example, the other terminal of the center pin 140 may press the second electrode tab 114 of the second electrode against the bottom portion of the case 120. The one terminal and the other terminal of the center pin 140 may be opposite to each other in the longitudinal direction of the center pin 140.

In some embodiments, the center pin 140 may be stretchable in the longitudinal direction. When the cap assembly 130 is joined to (e.g., connected to or attached to) the case 120, the center pin 140 may be compressed. The center pin 140 may press the first electrode tab 112 against the terminal plate 134, and may press the second electrode tab 114 against the case 120, by an elastic force generated as the center pin 140 is compressed.

As such, defects that may be caused by welding may be prevented by joining the cap assembly 130 and the case 120 to each other without welding the contact area or joining area thereof. In addition, because the first electrode tab 112 and the terminal plate 134 may be energized by the center pin 140, welding may not be necessary between the first electrode tab 112 and the terminal plate 134. Similarly, because the second electrode tab 114 and the case 120 may be energized by the center pin 140, welding may not be necessary between the second electrode tab 114 and the case 120. Accordingly, defects that may be caused by welding may be prevented.

FIG. 2 illustrates a partial enlarged view of a secondary battery according to some embodiments of the present disclosure. The secondary battery illustrated in FIG. may be the same or substantially the same as the secondary battery described above with reference to FIG. 1. Hereinafter, a joining relationship between the case and the cap assembly will be described in more detail.

In some embodiments, a cap plate 220 included in the cap assembly may include a cover portion 222 and a sidewall portion 224. The cover portion 222 may be located on one side of the case 210 where the opening is formed. The cover portion may cover the opening of the case 210.

The sidewall portion 224 may extend in a direction perpendicular to or substantially perpendicular to the cover portion 222. The sidewall portion 224 may be in contact with the outer surface of the case 210. In more detail, a first thread 212 may be formed on a portion of the outer surface of the case 210 corresponding to the side surface of the opening. A second thread 224a corresponding to the first thread 212 may be formed on the inner surface of the sidewall portion 224. By rotating the cap plate 220 in a state of being in contact with the side having the opening of the case 210, the first thread 212 and the second thread 224a may be engaged and joined (e.g., connected to or attached to) with each other. As such, the first thread 212 and the second thread 224a may be engaged with each other, such that the cap plate 220 and the case 210 may be joined to each other. The cap assembly including the cap plate and the case 210 may be easily joined to each other through the first thread 212 and the second thread 224a.

FIG. 3 illustrates a cross-sectional view of a secondary battery according to some embodiments of the present disclosure. In FIG. 3, the configuration of the cap assembly may be different from the configuration of the cap assembly of the secondary battery described above with reference to FIG. 1. Hereinafter with reference to FIG. 3, redundant description of the same or substantially the same (or similar) components as those of the secondary battery described above with reference to FIG. 1 may not be repeated, and the differences may be mainly described.

The cap assembly may include a cap plate 310, a terminal plate 320, and an insulating layer 330. An insertion hole may be formed in the cap plate 310. In more detail, the insertion hole may be formed approximately at the center of the cap plate 310. The terminal plate 320 may be inserted into the insertion hole, and the terminal plate 320 may be joined to (e.g., may be connected to or attached to) the cap plate 310. The terminal plate 320 may include a body portion 322, and an insertion portion 324 protruding from the body portion 322. The insertion portion 324 of the terminal plate 320 may be inserted into the insertion hole of the cap plate 310.

The cap plate 310 may include a cover portion 312, a circumferential portion 314, and a sidewall portion 316. At least a portion of the cover portion 312 may cover the opening of the case. At least a portion of the cover portion 312 may be disposed between the body portion 322 of the terminal plate 320 and the electrode assembly. The sidewall portion 316 may be joined to (e.g., may be connected to or attached to) the outer surface of the case corresponding to the side surface of the opening.

In some embodiments, the cap plate 310 may include the circumferential portion 314 surrounding (e.g., around a periphery of) the circumference of the side surface of the body portion 322 of the terminal plate 320. In more detail, the inner diameter of the circumferential portion 314 may be substantially equal to or greater than the diameter of the body portion 322. As an example, the thickness of the circumferential portion 314 may be less than or equal to the thickness of the insulating layer 330 and the body portion 322. As such, the cap plate 310 may protect the terminal plate 320 by alleviating a pressure or an impact from external objects.

Referring to FIG. 3, the cap assembly may be joined to (e.g., may be connected to or attached to) the case, so that the insertion portion 324 faces the electrode assembly. A first electrode tab of the first electrode of the electrode assembly may be electrically connected to the insertion portion 324 of the terminal plate 320. In more detail, a center pin may press the first electrode tab against the insertion portion 324, thereby allowing the first electrode tab and the insertion portion 324 to come into close contact with each other and be electrically connected to each other.

The insulating layer 330 may be disposed between the terminal plate 320 and the cap plate 310. Referring to FIG. 3, the insulating layer 330 may be disposed between the body portion 322 and the cover portion 312. As an example, an insulating layer insertion hole having a shape corresponding to the shape of the insertion hole of the cap plate 310 may be formed in the insulating layer 330. The insertion portion 324 of the terminal plate 320 may be inserted into the insulating layer insertion hole.

FIG. 4 illustrates a cross-sectional view of a secondary battery according to some embodiments of the present disclosure. In FIG. 4, the configuration of the cap assembly may be different from the configuration of the cap assembly of the secondary battery described above with reference to FIGS. 1 and 3. Hereinafter with reference to FIG. 4, redundant description of the components that are the same or substantially the same as (or similar) to those of the secondary battery described above with reference to FIGS. 1 and 3 may not be repeated, and the differences may be mainly described.

The cap assembly may include a cap plate 410, a terminal plate 420, and an insulating layer 430. An insertion hole may be formed in the cap plate 410. In more detail, the insertion hole may be formed approximately at the center of the cap plate 410. The terminal plate 420 may be inserted into the insertion hole, and the terminal plate 420 may be joined to (e.g., may be connected to or attached to) the cap plate 410. The terminal plate 420 may include a body portion 422, and an insertion portion protruding from the body portion 422. The insertion portion 424 of the terminal plate 420 may be inserted into the insertion hole of the cap plate 410.

The cap assembly may seal the opening of the case. In some embodiments, the body portion 422 of the terminal plate 420 and a portion of the cap plate 410 may be located on one side of the case where the opening is formed. The insertion portion may be formed on a first surface (e.g., an upper surface) of the body portion 422. A second surface (e.g., a lower surface) of the body portion 422 opposite to the first surface of the body portion 422 may be positioned on the opening of the case.

The cap plate 410 may include a cover portion 412, a circumferential portion 414, and a sidewall portion 416. At least a portion of the cover portion 412 may cover at least a portion of the first surface of the body portion 422 of the terminal plate 420. In this case, the insulating layer 430 may be disposed between the cover portion 412 and the body portion 422. The sidewall portion 416 may be joined to (e.g., may be connected to or attached to) the outer surface of the case corresponding to the side surface of the opening of the case.

The cap plate 410 may include the circumferential portion 414 surrounding (e.g., around a periphery of) the circumference of the side surface of the body portion of the terminal plate 420. In more detail, the inner diameter of the circumferential portion 414 may be substantially equal to or greater than the diameter of the body portion 422. As an example, the thickness of the circumferential portion 414 may be less than or equal to the thickness of the insulating layer 430 and the body portion 422.

Referring to FIG. 4, the cap assembly may be joined to (e.g., may be connected to or attached to) the case, such that the body portion 422 faces the electrode assembly. In more detail, the cap assembly may be joined to (e.g., may be connected to or attached to) the case so that the second surface of the body portion opposite the first surface of the body portion 422 faces the electrode assembly. In this case, the first electrode tab of the first electrode may be electrically connected to the body portion 422 of the terminal plate 420. In more detail, the center pin may press the first electrode tab against the body portion 422, thereby allowing the first electrode tab and the body portion 422 to come into close contact with each other and be electrically connected to each other.

The insulating layer 430 may be disposed between the terminal plate 420 and the cap plate 410. Referring to FIG. 4, the insulating layer 430 may be disposed between the body portion 422 and the cover portion 412. As an example, an insulating layer insertion hole having a shape corresponding to the shape of the insertion hole of the cap plate 410 may be formed in the insulating layer 430. The insertion portion 424 of the terminal plate 420 may be inserted into the insulating layer insertion hole.

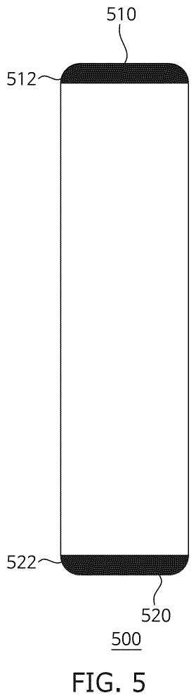

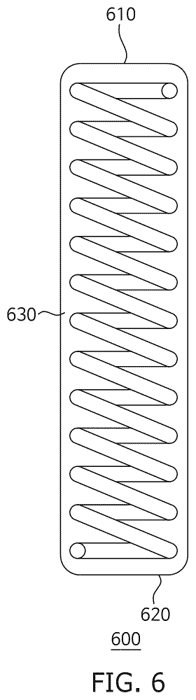

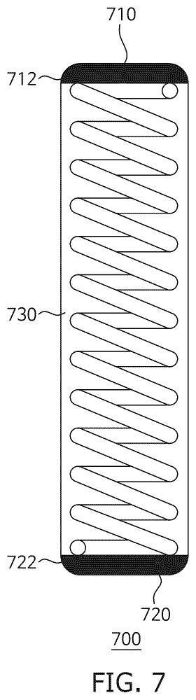

FIG. 5 illustrates an example of a center pin 500 according to some embodiments of the present disclosure. FIG. 6 illustrate an example of a center pin 600 according to some embodiments of the present disclosure. FIG. 7 illustrates an example of a center pin 700 according to some embodiments of the present disclosure.

The center pin 500 illustrated in FIG. 5 may be positioned inside the through-hole of the electrode assembly. The center pin 500 may be stretchable in the longitudinal direction. For example, the center pin 500 may include (e.g., may be formed of) a stretchable material, and may be compressed when an external force in the longitudinal direction is applied thereto. The center pin 500 may have a suitable elasticity to enable an expansion in response to being compressed by an external force.

The center pin 500 may include a first contact portion 510 in contact with the first electrode tab of the first electrode, and a second contact portion 520 in contact with the second electrode tab of the second electrode. In some embodiments, the first contact portion 510 and/or the second contact portion 520 may include low friction layers 512 and 522. For example, a first low friction layer 512 may be formed on the first contact portion 510. Similarly, a second low friction layer 522 may be formed on the second contact portion 520. Referring to FIG. 5, the low friction layers 512 and 522 may be formed in both ends (e.g., opposite ends) of the center pin 500, but the present disclosure is not limited thereto, and the low friction layer may be formed at only one end.

By the low friction layers 512 and 522, a friction force between one end of the center pin 500 and an object that are in physical contact with each other may be relatively reduced, as compared to a friction force between one end of the center pin and an object in physical contact with each other in a state in which no low friction layer is formed. For example, a friction force between one end of the center pin 500 and the object may be reduced by the low friction layers 512 and 522. Accordingly, even if the center pin 500 is pressed or contacted by the terminal plate, the electrode tab (e.g., the first electrode tab or the second electrode tab), or the case, damage to the terminal portion of the center pin 500 or other parts in contact therewith may be reduced.

In some embodiments, the low friction layers 512 and 522 may include a binder. The binder may be a suitable material that helps positive electrode active material particles of the secondary battery to be bonded well to each other, and may also help the positive electrode active material to be bonded well to the current collector. For example, the binder may include polytetrafluoroethylene (PTFE) or polyvinylidenefluoride (PVDF).

Referring to FIG. 6, the center pin 600 may be the same or substantially the same as the center pin 500 described above with reference to FIG. 5, except for the low friction layers 512 and 522. In addition, in FIG. 6, the center pin 600 may include an elastic portion 630. The elastic portion 630 may be stretchable in the longitudinal direction of the center pin 600. For example, the elastic portion 630 may include (e.g., may be) a spring. However, the present disclosure is not limited thereto, and any suitable structure that is stretchable and has a suitable elastic force may be used as the elastic portion 630.

In some embodiments, the elastic portion 630 may be positioned between a first contact portion 610 and a second contact portion 620. In addition, the elastic portion 630 may be located inside the center pin 600. For example, the center of the elastic portion 630 may be positioned at the center with respect to the longitudinal direction of the center pin 600. In this case, a degree of elastic force that expands and contracts in response to the external force applied to opposite ends of the center pin may be equal or substantially equal for the opposite ends of the center pin 600. For example, regarding the external forces applied to the first contact portion 610 and the second contact portion 620 of the elastic portion 630, respectively, the elastic portion 630 may have a structure or a configuration so that the elastic forces generated in the first contact portion 610 and the second contact portion 620 are equal to or substantially equal to each other.

Referring to FIG. 7, the center pin 700 may be obtained by including the elastic portion 630 of FIG. 6 to the center pin 500 of FIG. 5. In other words, the center pin 700 may include a first low friction layer 712 formed on the first contact portion 710, and a second low friction layer 722 formed on the second contact portion 720. In addition, the center pin 700 may include an elastic portion 730 positioned between the first contact portion 710 and the second contact portion 720.

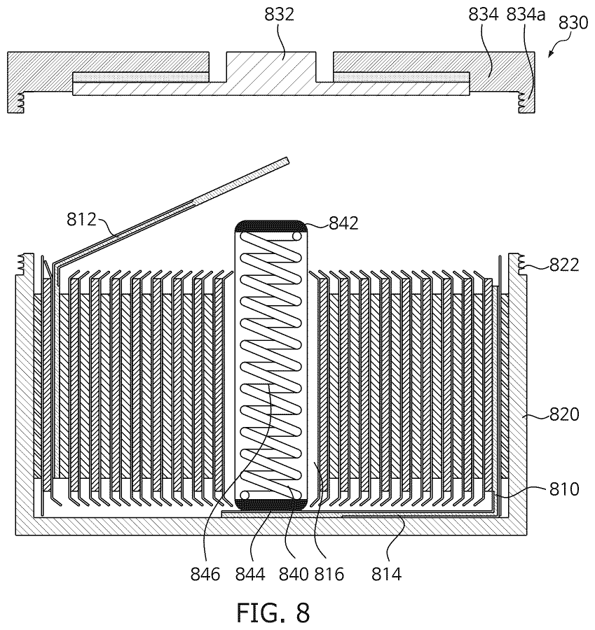

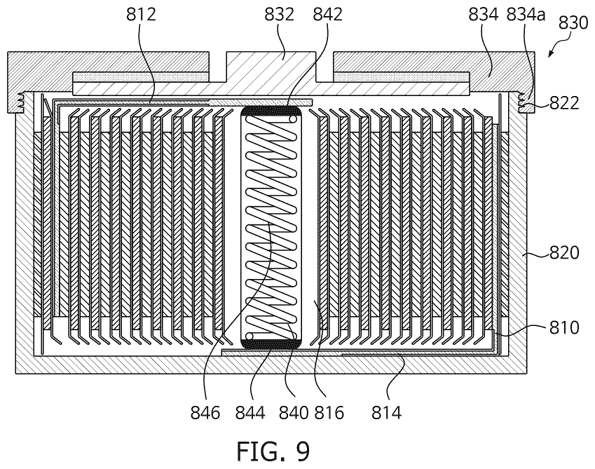

FIG. 8 illustrates a case 820 and a cap assembly 830 before being joined to each other according to some embodiments of the present disclosure. FIG. 9 illustrates the case 820 and the cap assembly 830 after being joined to each other according to some embodiments of the present disclosure. Each of the secondary batteries illustrated in FIGS. 8 and 9 may be the same or substantially the same as the secondary battery described above with reference to FIG. 3, except for a center pin thereof may be different. The center pin 840 illustrated in FIG. 8 may be the same or substantially the same as the center pin 700 described above with reference to FIG. 7. As such, a process of joining the case 820 to the cap assembly 830 may be mainly described hereinafter with reference to FIGS. 8 and 9.

Referring to FIG. 8, an electrode assembly 810 may be accommodated in the case 820. The electrode assembly 810 may include a first electrode tab 812 connected to the first electrode, and a second electrode tab 814 connected to the second electrode. The second electrode tab 814 may be bent under the electrode assembly 810, and may be in contact with the bottom of the case 820.

The center pin 840 may be inserted into a through-hole 816 of the electrode assembly 810. The center pin 840 may include a first contact portion 842 and a second contact portion 844. The second contact portion 844 may be disposed on the second electrode tab 814.

The cap assembly 830 may include a terminal plate 832, an insulating layer, and a cap plate 834, which are joined to (e.g., connected to or attached to) each other. The cap assembly 830 may be joined toward one side of the case 820 where the opening is formed. However, the present disclosure is not limited thereto, and the cap assembly 830 may be joined to (e.g., may be connected to or attached to) the case in a separate state.

Referring to FIG. 9, a first thread 822 may be formed on the outer surface of the case 820 corresponding to the side surface of the opening. A second thread 834a may be formed on the inner surface of the sidewall portion of the cap plate 834. As the first thread 822 and the second thread 834a are engaged with each other, the cap assembly 830 may be rotationally joined to (e.g., may be rotationally connected to or attached to) the case 820.

When the cap assembly 830 is joined to the case 820, the first electrode tab 812 may be pressed by the cap assembly 830, and bent in a direction toward the center pin 840. The first electrode tab 812 may be in contact with the first contact portion 842 and the terminal plate 832. In addition, the first electrode tab 812 may be pressed against the terminal plate 832 by the center pin 840. Similarly, the second electrode tab 814 may be in contact with the second contact portion 844 and the case 820. In addition, the second contact portion 844 may be pressed against the case 820 by the center pin 840.

In more detail, as the cap assembly 830 and the case 820 are joined to each other, the stretchable center pin 840 may be compressed. In this case, the elastic portion 846 formed in the center pin 840 may be compressed. The center pin 840 may press the first electrode tab 812 against the terminal plate 832, and may press the second electrode tab 814 against the case 820, by an elastic force generated as the center pin 840 is compressed. Accordingly, the first electrode tab 812 may be closely connected to the terminal plate 832 to maintain energization, and the second electrode tab 814 may be closely connected to the case 820 to maintain energization.

When the cap assembly 830 is rotated with respect to the case 820 so that the cap assembly 830 is joined to the case 820, friction may occur due to a contact between the first contact portion 842 and the cap assembly 830 and/or the first electrode tab 812. In this case, due to the first low friction layer formed on the first contact portion 842, the first electrode tab 812, the first contact portion 842, and the terminal plate 832 may not be damaged. Similarly, when the cap assembly 830 is rotated with respect to the case 820 so that the cap assembly 830 is joined to the case 820, friction may occur due to a contact between the second contact portion 844 and the case 820 and/or the second electrode tab 814. In this case, due to the second low friction layer formed on the second contact portion 844, the second electrode tab 814, the second contact portion 844, and the case 820 may not be damaged.

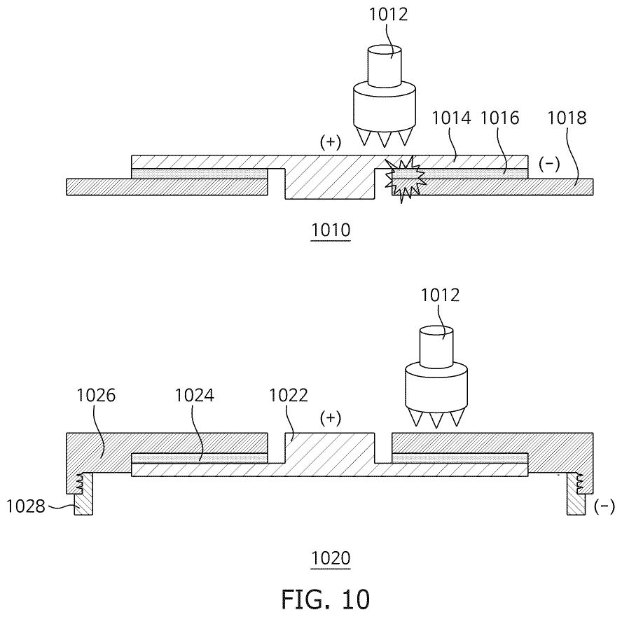

FIG. 10 illustrates an example of a configuration of preventing a short circuit of a secondary battery. A first example 1010 may illustrate the configuration of a cap assembly including a cap plate 1018 formed of a conductive metal (e.g., aluminum or stainless steel) in a secondary battery. The cap assembly may include a terminal plate connected to a positive electrode, and a cap plate 1018 connected to a negative electrode. The cap assembly may include an insulating layer 1016 disposed between the terminal plate 1014 and the cap plate 1018. The insulating layer 1016 may prevent a short circuit between the terminal plate 1014 and the cap plate 1018.

In the first example 1010, an impact may be applied to the cap assembly by an external object 1012. In this case, the insulating layer 1016 may be damaged, and a short circuit may occur between the terminal plate 1014 and the cap plate 1018. In particular, when the thickness of the terminal plate 1014 becomes thinner, damage to the insulating layer 1016 may occur more easily.

A second example 1020 may show a secondary battery including the same or substantially the same configuration as that of the cap assembly described above with reference to FIG. 4. A terminal plate 1022 may be connected to a positive electrode, and a case 1028 may be connected to a negative electrode. A cap plate may include an insulating material, and may not be energized with the case 1028. An insulating layer 1024 may be disposed between the cap plate 1026 and the terminal plate 1022.

In the second example 1020, an impact may be applied to the cap assembly by an external object 1012. In this case, a cover portion of the cap plate 1026 may be located at the outermost portion, and thus, damage to the terminal plate 1022 may be minimized or reduced. As another example, even if an impact is applied to the cap plate 1026 and the insulating layer 1024 and the cap plate 1022 are damaged, a short-circuit may not occur in the positive electrode and the negative electrode connected to the terminal plate 1022, because the cap plate 1026 includes an insulating material. As such, the secondary battery according to one or more embodiments of the present disclosure may be made relatively safe by reducing the risk of a short circuit.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

What is claimed is:

1. A secondary battery comprising:
an electrode assembly comprising a first electrode, a second electrode, and a separator wound between the first electrode and the second electrode, the electrode assembly having a through-hole in a core portion;
a case configured to accommodate the electrode assembly inserted through an opening in one side of the case, the case comprising a first thread on a side surface of the opening;
a cap assembly configured to seal the opening of the case, and comprising a cap plate having a sidewall portion comprising a second thread to correspond to the first thread; and
a center pin located inside the through-hole, and configured to be stretched in a longitudinal direction.

2. The secondary battery as claimed in claim 1, wherein the cap assembly further comprises a terminal plate electrically connected to the first electrode, and
wherein one terminal of the center pin is configured to press a first electrode tab of the first electrode against at least a portion of the terminal plate.

3. The secondary battery as claimed in claim 1, wherein one terminal of the center pin is configured to press a second electrode tab of the second electrode against at least a portion of the case.

4. The secondary battery as claimed in claim 1, wherein the center pin comprises:
a first contact portion in contact with a first electrode tab of the first electrode; and
a second contact portion in contact with a second electrode tab of the second electrode, and
wherein at least one of the first contact portion or the second contact portion comprises a surface having a low friction layer thereon.

5. The secondary battery as claimed in claim 4, wherein the low friction layer comprises a binder.

6. The secondary battery as claimed in claim 1, wherein the center pin comprises an elastic portion configured to be stretched along the longitudinal direction.

7. The secondary battery as claimed in claim 6, wherein opposite terminals of the center pin are configured to be compressed by the cap assembly and the case, as the cap assembly and the case are attached to each other.

8. The secondary battery as claimed in claim 7, wherein the cap assembly further comprises a terminal plate electrically connected to the first electrode, and
wherein the center pin is configured to press a first electrode tab of the first electrode against the terminal plate, and press a second electrode tab of the second electrode against the case by an elastic force generated when the center pin is compressed.

9. The secondary battery as claimed in claim 1, wherein the second thread of the cap plate is configured to be engaged with the first thread of the case to attach the cap assembly to the case.

10. The secondary battery as claimed in claim 1, wherein the cap plate comprises an insulating material.

11. The secondary battery as claimed in claim 1, wherein the cap assembly further comprises a terminal plate electrically connected to the first electrode, and
wherein the terminal plate comprises a body portion, and an insertion portion protruding from the body portion.

12. The secondary battery as claimed in claim 11, wherein the cap plate further comprises a circumferential portion surrounding around a circumference of a side surface of the body portion.

13. The secondary battery as claimed in claim 11, wherein the insertion portion of the terminal plate faces the electrode assembly when the cap assembly is attached to the case.

14. The secondary battery as claimed in claim 13, wherein the cap plate comprises a first cover portion, and
wherein at least a portion of the first cover portion is located between the body portion of the terminal plate and the electrode assembly.

15. The secondary battery as claimed in claim 14, wherein the cap assembly further comprises a first insulating layer between the first cover portion of the cap plate and the body portion of the terminal plate.

16. The secondary battery as claimed in claim 11, wherein one surface of the body portion opposite the insertion portion faces the electrode assembly when the cap assembly is attached to the case.

17. The secondary battery as claimed in claim 16, wherein the cap plate further comprises a second cover portion, and
wherein at least a portion of the second cover portion is located on the body portion of the terminal plate.

18. The secondary battery as claimed in claim 17, wherein the cap assembly further comprises a second insulating layer between the second cover portion of the cap plate and the body portion of the terminal plate.

19. A secondary battery comprising:
an electrode assembly comprising a first electrode, a second electrode, and a separator wound between the first electrode and the second electrode, the electrode assembly having a through-hole in a core portion;
a case configured to accommodate the electrode assembly inserted through an opening in one side of the case, the case being electrically connected to a second electrode tab;
a cap assembly configured to seal the opening of the case, and comprising a terminal plate connected to the first electrode; and
a center pin inside the through-hole, and configured to be stretched in a longitudinal direction,
wherein a side surface of the opening of the case comprises a first thread, and a circumferential portion of the cap assembly comprises a second thread corresponding to the first thread, and
wherein one terminal of the center pin is configured to press a first electrode tab of the first electrode against the terminal plate, and another terminal of the center pin is configured to press the second electrode tab of the second electrode against the case, as the first thread of the case and the second thread of the cap assembly are engaged and connected with each other.

20. The secondary battery as claimed in claim 19, wherein the center pin comprises:
a first contact portion in contact with the first electrode tab of the first electrode; and
a second contact portion in contact with the second electrode tab of the second electrode, and
wherein at least one of the first contact portion or the second contact portion comprises a surface having a low friction layer thereon.
